(19) United States
(12) Patent Application Publication
(10) Pub. No.: US 2025/0389158 A1
(43) Pub. Date: Dec. 25, 2025

(54) Ladder Securing Device for a Tree or Pole

(71) Applicant: Fred Barker, Oceanside, CA (US)

(72) Inventor: Fred Barker, Oceanside, CA (US)

(21) Appl. No.: 19/245,256

(22) Filed: Jun. 21, 2025

Related U.S. Application Data
(63) Continuation-in-part of application No. 19/018,459, filed on Jan. 13, 2025.
(60) Provisional application No. 63/625,181, filed on Jan. 25, 2024.

(51) Int. Cl. E06C 7/48

(52) U.S. Cl. CPC E06C 7/48

(57) ABSTRACT

Improvements in a ladder securing device for a tree, or a pole to safely secure a ladder to a tree or pole from the ground before a user ascends the ladder. The securing device is loosely fastened around the tree or pole and then lifted with the ladder to the highest position. This ensures that all the ladder raising, and rope or strap positioning is performed from the ground level. An additional tightening feature may be placed at or near the top of the ladder or at one or more positions of the ladder so the user can make any additional adjustments as they ascend, and the position of a tree may change based upon the load of the ladder on the tree. The user releases rope cord or strap from the ground after they are no longer on the ladder.

### CROSS-REFERENCE TO RELATED APPLICATIONS

This application claims the benefit of Non-Provisional Utility application Ser. No. 19/018,459 filed on Jan. 13, 2025, that claims the benefit of Provisional Application Ser. No. 63/625,181 filed Jan. 25, 2024, the entire contents of which is hereby expressly incorporated by reference herein.

### PRIOR ART

U.S. Pat. No. 3,792,756 issued on Feb. 19, 1974, to Herbert Kelly and is titled Safety Attachment for Ladder. This patent discloses a conventional ladder means with the upper ends of the parallel side members terminating in a pair of right and left brackets, which brackets retain the end portions of an adjustable abrasive coated front belt for contact against the front side of a pole or tree with a second adjustable strap means pivotally secured to opposite brackets for snugly surrounding the rear portion of said pole or tree for preventing displacement of the ladder when in use. While this patent discloses a securing mechanism for a tree, the device requires a user to climb to the top of the ladder to secure the strap.

U.S. Pat. No. 4,545,460 issued on Oct. 8, 1985, to James L. Byrd and is titled Ladder Fastening Device for Pole Climbing. This patent discloses a ladder fastening device for pole climbing. The device includes a central strap portion operable to be wrapped around a pole and having free end portions. A pair of end straps are included each connected to a different end of the central strap portion and operable to be wrapped about the legs of a ladder previously leaned against the pole. Each of the end straps has a pair of rigid buckles connected to an end for engaging the free end of the central strap portion. There is included at the other end of each end strap a latching means for looping each end strap around one of the legs. While this patent discloses a strap that is secured around a pole, it requires the user to climb the pole to both wrap and unwrap the strap from around the pole.

U.S. Pat. No. 10,294,721 issued on May 21, 2019, to Hosseim Jafarmader and is titled Ladder for Narrow Structures. This patent discloses a ladder assembly configured for being supported on narrow surfaces. The ladder assembly may include a receiving structure that is configured to receive a narrow structure such as a tree or pole, for safely leaning the ladder assembly against the narrow structure. The assembly may include an arm that is operable between an open and closed position for securing the narrow structure in the receiving structure. The assembly may include an anchor to secure the ladder to a proximal surface that supports the ladder. While this patent discloses a securing mechanism that secures the upper end of the ladder to the pole, the final securing mechanism of the strap must be installed by the user at the top of the ladder.

U.S. Published application 2011/0209944 was published on Sep. 1, 2011, and is titled Deer Stand Securable from Ground. This publication discloses light weight, packable ladder stands generally used for hunting. It is made of aluminum parts and can be folded, demounted or slid into a backpack configuration that weighs about thirty pounds with an aluminum ladder. The weight may be further reduced in alternate ladder configurations, such as reinforced plastic ladder. The ladder stand can be anchored to the tree by a single person from the ground location without having to climb the ladder. This allows the deer stand to be easily transported and installed by a lone hunter without climbing the ladder prior to securing the ladder to the tree. While this publication discloses a stand that can be erected from the ground, the actual securing, and removal is from while climbing the stand.

What is needed is a ladder with a securing and unsecuring mechanism that can be tightened and loosened from the ground without requiring the user to ascend any rungs of the ladder. The ladder securing device for a tree, or a pole disclosed in this document provides the solution.

### BACKGROUND OF THE INVENTION

For workers from tree trimmers, linemen and electrical or other workers need to safely climb a ladder that is supported on the elevated side on a tree, pole or other vertical element. Safety is a top concern, and the ladder should be properly and firmly secured before a user begins any ascent of the ladder to perform work. The ladder securing device for a tree, or a pole needs to have a securing means that can be both secured and unsecured from the tree or pole from the ground level for maximum safety.

### SUMMARY OF THE INVENTION

It is an object of the ladder securing device for a tree, or a pole to provide a ladder that can be safely secured to a tree or pole from the ground before a user ascends the ladder. This is important when the angle of the ground, the surface under the ground or the position of the tree or pole is not stable. Ascending a ladder to secure the ladder is an unsafe operation and solving this problem is important to the worker.

It is an object of the ladder securing device for a tree, or a pole to provide a rope, cord or strap that can be loosely fastened around the tree or pole and then lifted with the ladder to the highest position. This ensures that all of the ladder raising, and rope or strap positioning is performed from the ground level.

It is another object of the ladder securing device for a tree, or a pole to provide an additional tightening feature with the user has ascended the ladder to the working position. The additional tightening feature can be placed at or near the top of the ladder or at one or more positions of the ladder so the user can make any additional adjustments as they ascend, and the position of a tree may change based upon the load of the ladder on the tree.

It is still another object of the ladder securing device for a tree, or a pole to provide to allow the user to release the securing rope cord or strap from the ground after they are no longer on the ladder. After removing the securing mechanism, the ladder can be lowered and removed for use at another time and location as needed.

Various objects, features, aspects, and advantages of the present invention will become more apparent from the following detailed description of preferred embodiments of the invention, along with the accompanying drawings in which like numerals represent like components.

### BRIEF DESCRIPTION OF DRAWINGS

FIG. 1A shows a ladder securing device for a tree, or a pole.

FIG. 1B shows the ladder securing device for a tree, or a pole with the strap loosely secured around a tree.

FIG. 2A shows the ladder securing device for a tree, or a pole extended.

FIG. 2B shows the ladder securing device for a tree, or a pole being tightened from the ground.

FIG. 3 shows the ladder securing device for a tree, or a pole tightened around the tree.

FIG. 4 shows the securing strap.

FIG. 5 shows the tightening ratchet.

FIG. 6 shows a view of the ladder topper at the end of the ladder.

FIG. 7 shows a perspective view of the ladder topper in use.

### DETAILED DESCRIPTION OF THE INVENTION

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention but is merely representative of various embodiments of the invention. The illustrated embodiments of the invention will be best understood by reference to the drawings, wherein like parts are designated by like numerals throughout.

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated. The terminology used herein is for the purpose of describing particular embodiments only and is not intended to be limiting of the technology. As used herein, the singular forms “a,” “an,” and “the” are intended to include the plural forms as well, unless the context clearly indicates otherwise.

It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof. It will be understood that like or analogous elements and/or components, referred to herein, may be identified throughout the drawings with like reference characters.

Item Numbers and Description

| | |
|---|---|
| 18 user | 19 tree or pole |
| 20 ladder with securing device | 21 outer ladder |
| 22 inner ladder | 23 rung hole |
| 24 rung | 25 strap |
| 29 lower rung | 30 Kevlar ® chafing guard |
| 31 rope or cord | 32 drawn rope |
| 33 tree pad | 34 level |
| 40 carabiner | 50 ratchet clamp |
| 60 ladder topper | 61 centering notch |
| 62 fastener(s) | 63 angle |
| 64 wedge | |

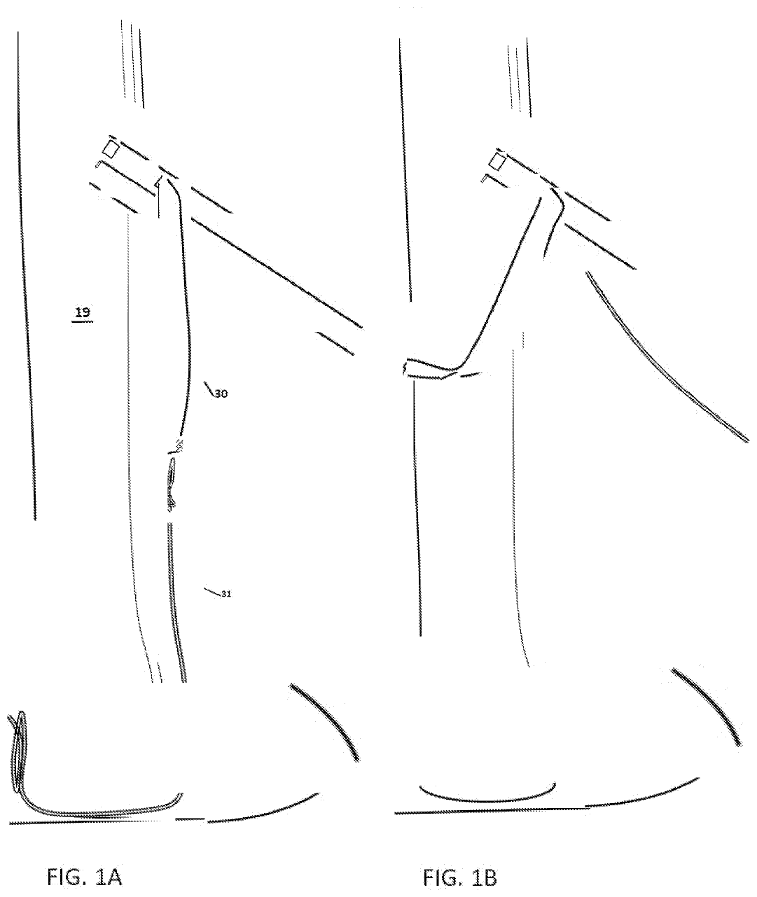

FIG. 1A shows a ladder securing device 20 for a tree 19, or a pole and FIG. 1B shows the ladder securing device 20 for a tree 19, or a pole with the Kevlar® chafing guard 30 loosely secured around tree 19. In the left figure a user will rest the ladder against tree 19 such that the user can grasp the free end of the Kevlar® chafing guard 30 that is connected to a rope 31 or cord. The user will then loosely wrap the Kevlar® chafing guard 30 around tree 19 or pole and secure the rope 31 into a carabiner, D-ring, ring or other loop on the other side of the ladder (not shown in this figure), thereby leaving the Kevlar® chafing guard 30 loosely around tree 19. The loose end of rope 32 is then brought to the bottom of ladder 19.

Ladder 19 is this example is an extension ladder having an inner ladder section 21 and an outer ladder section 22, but can be a different type of ladder or could have more than two extension ladder sections 21 and 22. The ladder is shown as an aluminum ladder, but could be constructed from wood, a composite material or equivalence. The aluminum ladder in this example has rung holes 23 that support the foot supporting rungs. The loose end of the rope 32 is pulled to tighten the strap around the tree 19. From this loose condition of the Kevlar® chafing guard 30 the ladder can be easily elevated up the side of the tree 19 to a higher position where the user will need to work.

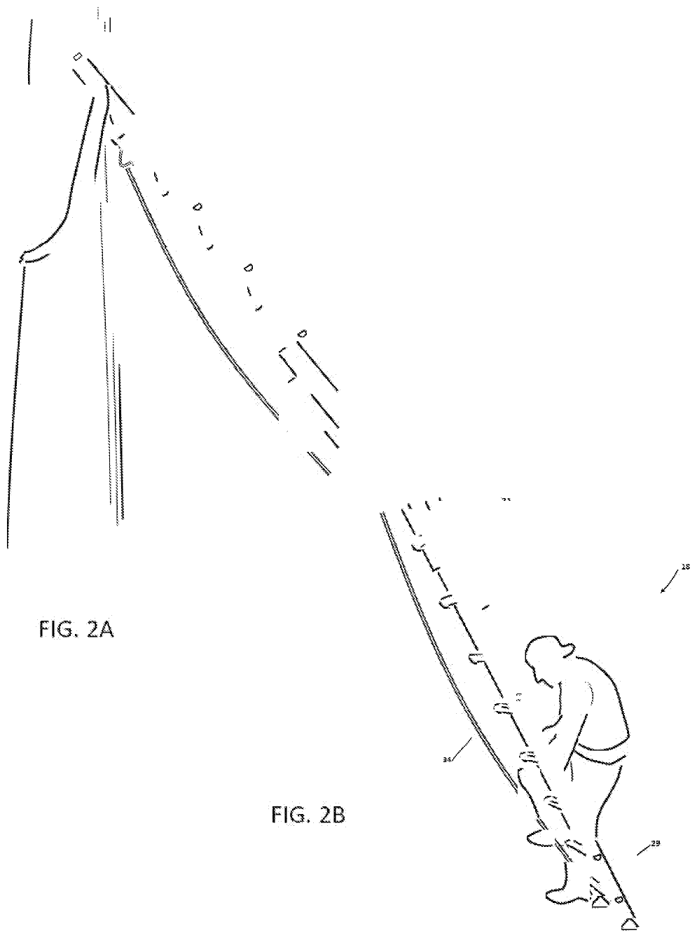

FIG. 2A shows the ladder securing device for tree 20, or a pole extended and FIG. 2B shows the ladder securing device for tree 20, or a pole being tightened from the ground. In FIG. 2A the ladder is extended to the desired height on tree 19 with the inner ladder section 21 against the tree with the upper rung in contact with tree 19. The rung hole 23 is shown with a rung 24. The inner ladder section 21 is shown extending from the outer ladder section 22. The Kevlar® chafing guard 30 is still loosely wrapped around the tree 19 and on the other side of the tree the connected rope 31 is shown passing through a with rope 31 extending through a carabiner 40 so the rope 31 extends towards the end of the ladder to a user 18 and shown in FIG. 2B.

In FIG. 2B the user 18 has collected the end of the rope 31 and is shown using a ratchet clamp 50 or similar device to tighten the rope 31 from the carabiner 40, around the lower rung 29 to bind the Kevlar® chafing guard 30, from the upper rung, around the tree 19, through the carabiner 40 and around the lower rung 29. This creates a tight bind of the ladder to tree 19 with the user 18 remaining on the ground. The process is essentially revered to remove the ladder from the tree by the user 18 on the ground and loosening or removing the rope 31 and Kevlar® chafing guard 30, then lowering the ladder to remove the strap from the carabiner 40. Level 34 indicates the proper angle of the ladder. Level 34 is preferably installed approximately 5 ft from the ground on the same side as the ratchet but shown here on the opposite side. It is also contemplated that level 34 can be placed or integrated into a rung of the ladder with securing device 20. Level 34 is preferably placed at an elevation of between 4 and 6 feet from the bottom of the ladder.

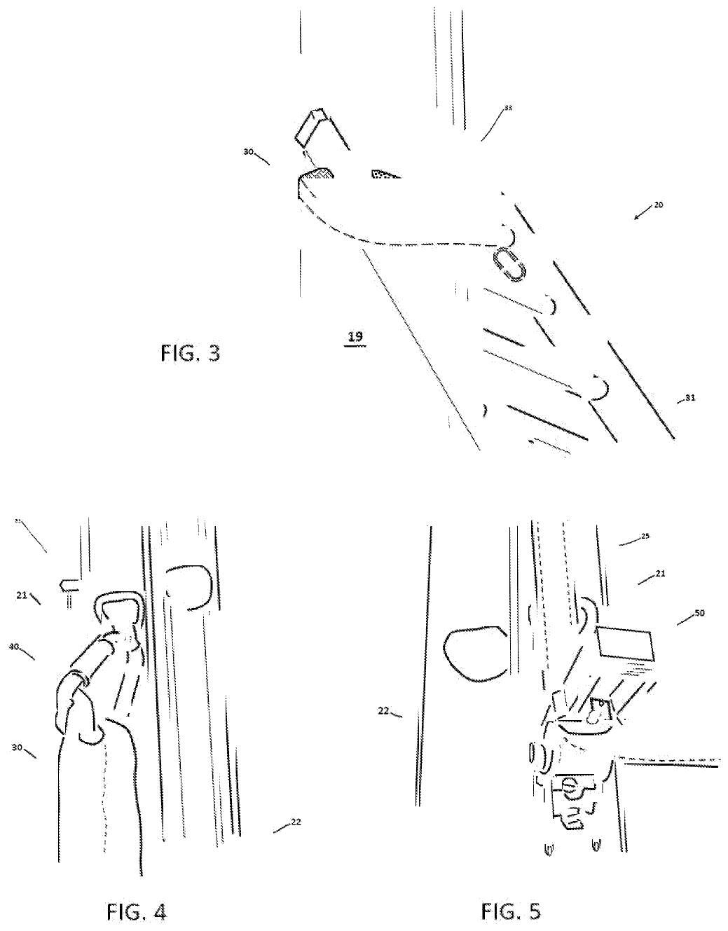

FIG. 3 shows the ladder securing device 20 for a tree 19, or a pole tightened around the tree. This figure shows the Kevlar® chafing guard 30 tightened around tree 19 and binding the ladder to tree 19 with the upper rung 24 in contact with the trunk of tree 19. Rope 31 is shown in a hidden line passing along the ladder where it is secured to the lowest rung of the ladder as previously shown and described with the sides of the outer ladder 21 in contact or alongside tree 19. While the embodiments shown use the lowest rung of the ladder, it could be secured at any location whereby the user 18 can secure the ladder to the tree 19 from the ground. This figure also shows tree pad 33 that can be used to cushion the top rung off the ladder against a tree to reduce or eliminate damage to the tree or palm.

FIG. 4 shows the securing Kevlar® chafing guard 27 wrapped around the carabiner 40. Kevlar® is a poly-para-phenylene terephthalamise or nylonlike polymer. The carabiner 40 can be opened so the Kevlar® chafing guard 27 can pass out of the center of the carabiner 40 or the Kevlar® chafing guard 27 can be untied. In this figure the rope cord or strap 31 is shown passing through the rung of the outer ladder 21 against the inner ladder 22. The aluminum ladder allows strap 31 to pass from one side to the other of the ladder without requiring a user to navigate around Kevlar® chafing guard 27, cord rope or another strap 31. Kevlar® chafing guard 27 allows the webbing strap to slide up the pole or palm without snagging.

FIG. 5 shows the tightening ratchet clamp 50. The ratcheting clamp 50 is shown secured to the outer ladder 21 section. The strap 25 passes into the ratchet 50 where it can be tightened with the mechanical advantage created by the lever action of the ratcheting clamp 50. Inner ladder 22 is shown in contact with the outer ladder 21. In other contemplated embodiments a ratcheting carabiner is not used and rope 31 is manually knotted and tightened to secure the ladder to a tree or pole.

FIG. 6 shows a view of the ladder topper 60 at the end of the ladder 21. The ladder topper 60 is secured to the ladder 21 with at least two fasteners 62. The fasteners 62 secure into the vertical rails of the ladder 21. The ladder topper 60 has a rear flat end and a front end with a “V” shaped notch. In the embodiment shown the “V” shaped notch is a centering notch 61 point. Other contemplated embodiments have a radius at the center or could have a flat that in the center. The angle 63 of the “V” is contemplated as from 90 degrees to less than 180 degrees or more preferably between 120 and 150 degrees and even more preferably about 130 degrees.

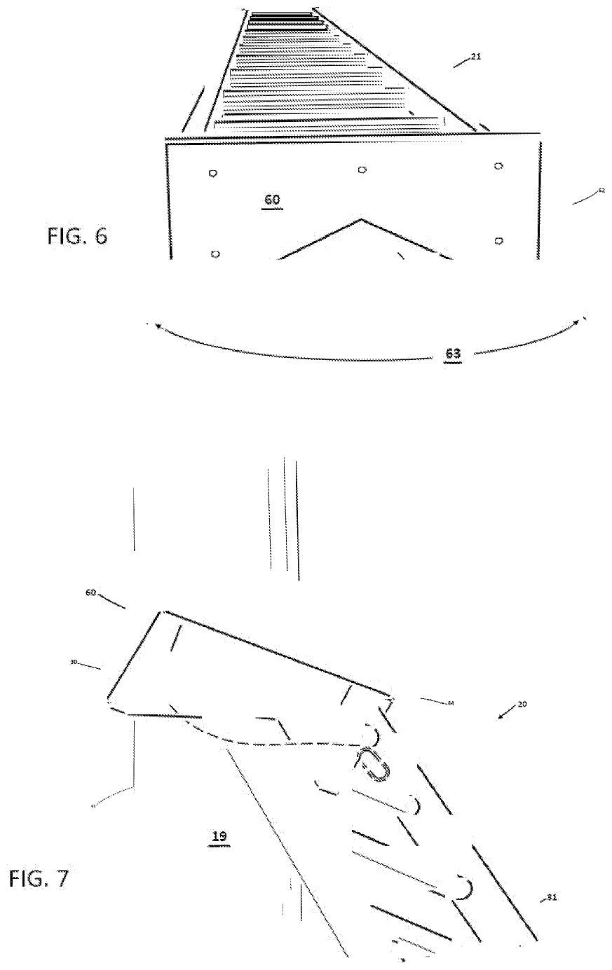

FIG. 7 shows a perspective view of the ladder topper 60 in use. In the embodiment shown an optional wedge 64 may be incorporated to change the perpendicular orientation of the ladder topper 60 to the ladder 21. The wedge 64 allows for the top surface of the ladder topper 60 to be more parallel to the ground surface to provide a flat surface for a user to stand upon. It is also contemplated that the previously mentioned chaffing guard can be incorporated into the area that makes contact with the tree or pole 19 to prevent or reduce abrasion. The ratcheting clamp 50 is shown secured to the outer ladder 21 section. The strap 25 passes into the ratchet 50 where it can be tightened with the mechanical advantage created by the lever action of the ratcheting clamp 50. Inner ladder 22 is shown in contact with the outer ladder 21. In other contemplated embodiments a ratcheting carabiner is not used and rope 31 is manually knotted and tightened to secure the ladder to a tree or pole 19.

Thus, specific embodiments of a ladder securing device for a tree, or a pole have been disclosed. It should be apparent, however, to those skilled in the art that many more modifications besides those described are possible without departing from the inventive concepts herein. The inventive subject matter, therefore, is not to be restricted except in the spirit of the appended claims.

1. A ladder securing device for a tree, or a pole to provide a comprising:
a ladder having a first end with a strap secured at a first end to an upper rung;
said first end of said ladder having a topper that is configured to center said ladder on said tree or said pole;
said strap having sufficient length to pass around a tree or pole;
said strap being configured to be temporally wrapped around said tree or pole and then be temporally secured to a ring at said upper rung at an opposite side of said upper ring of said ladder;
said strap further configured to extend to a second ground end of said ladder to a securing mechanism whereby;
said strap is configured to be tightened and loosened to said tree or said pole from said second ground end of said ladder.

2. The ladder securing device for a tree, or a pole according to claim 1, wherein said ladder is an extension ladder having at least two sections.

3. The ladder securing device for a tree, or a pole according to claim 1, wherein said topper has at least one “V” wedge opening on at least one side.

4. The ladder securing device for a tree, or a pole according to claim 1, wherein said strap passes through at least one hollow rung of said ladder.

5. The ladder securing device for a tree, or a pole according to claim 3, wherein said “V” wedge has an angle of between 90 and less than 180 degrees.

6. The ladder securing device for a tree, or a pole according to claim 1, wherein said securing mechanism is a ratcheting clamp.

7. The ladder securing device for a tree, or a pole according to claim 1, further includes a carabiner that connects said strap to a rope or cord.

8. The ladder securing device for a tree, or a pole according to claim 1, wherein said securing mechanism is manually knotted and tightened said strap to said ladder.

9. The ladder securing device for a tree, or a pole according to claim 1, wherein said securing mechanism is manually knotted and tightened said strap to said tree or pole.

10. The ladder securing device for a tree, or a pole according to claim 1, wherein said strap is a Kevlar chafing guard.

11. The ladder securing device for a tree, or a pole according to claim 1, further includes at least one level on said ladder.

12. The ladder securing device for a tree, or a pole according to claim 1, further includes a wedge between said ladder and said ladder topper.

13. The ladder securing device for a tree, or a pole according to claim 11, wherein said at least one level is on at least one side of said ladder.

14. The ladder securing device for a tree, or a pole according to claim 11, wherein said level indicates a safe angle of said ladder relative to vertical.

15. The ladder securing device for a tree, or a pole according to claim 11, wherein said level is placed at an elevation of between 4 and 6 feet from a bottom of said ladder.

16. The ladder securing device for a tree, or a pole according to claim 11, wherein said level is placed at a same side of said ladder as said securing mechanism.

17. The ladder securing device for a tree, or a pole according to claim 1, further includes a tree pad.

18. The ladder securing device for a tree, or a pole according to claim 15, wherein said tree pad at least partially wraps around said upper rung.

19. The ladder securing device for a tree, or a pole according to claim 1, wherein said ladder securing device is installed and removed from said tree or pole while said user is at a same elevation as said second ground end of said ladder.

20. The ladder securing device for a tree, or a pole according to claim 1, wherein said strap is made from nylon or a nylon like polymer.
